(19) United States
(12) Patent Application Publication
(10) Pub. No.: US 2021/0365010 A1
(43) Pub. Date: Nov. 25, 2021

(54) AUTHENTIC PREDEFINED MARK FORMATION

(71) Applicant: HEWLETT-PACKARD DEVELOPMENT COMPANY, L.P., Spring, TX (US)

(72) Inventor: Wei Huang, Palo Alto, CA (US)

(21) Appl. No.: 16/606,764

(22) PCT Filed: Apr. 30, 2018
(86) PCT No.: PCT/US2018/030270

§ 371 Date: Oct. 20, 2019

(51) Int. Cl. G05B 19/418

(52) U.S. Cl. CPC G05B 19/4183; G05B 2219/32127

(57) ABSTRACT

According to examples, an apparatus may include a processor and a memory on which are stored machine readable instructions. The instructions, when executed by the processor, may cause the processor to receive a file including data of an object to be fabricated and data of a predefined mark to be formed on the object and determine whether the predefined mark is authentic. The instructions may also cause the processor to, based on a determination that the predefined mark is authentic, control fabricating components to fabricate the object, and control the fabricating components to form the predefined mark on the object during fabrication of the object.

### BACKGROUND

A number of methods are used to prevent counterfeiting and provide authentication of printed media as well as objects fabricated through three-dimensional (3D) printing. These methods include, for instance, including seals, watermarks, specialized identifiers, or the like, on the printed media or objects. The specialized identifiers may include barcodes or quick response (QR) codes. In addition, the specialized identifiers may identify the manufacturer of an object or the author or publisher of printed media.

### BRIEF DESCRIPTION OF DRAWINGS

Features of the present disclosure are illustrated by way of example and not limited in the following figure(s), in which like numerals indicate like elements, in which:

FIG. 1 depicts a block diagram of an example apparatus that may include a processor to control formation of a predefined mark on an object;

FIG. 2 depicts a block diagram of an example fabricating system within which the apparatus depicted in FIG. 1 may be implemented;

FIG. 3 shows a block diagram of another example apparatus that may include a processor to control formation of a predefined mark on an object based on authentication status of the predefined mark;

FIGS. 4 and 5, respectively, depict flow diagrams of example methods for controlling formation of a predefined mark on an object; and

FIG. 6. shows an example non-transitory machine-readable storage medium for controlling, based on an authentication status of a predefined mark, formation of the predefined mark on an object.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the embodiments and examples. Furthermore, the examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, fabricating systems, and methods for controlling formation of a predefined mark on an object based on an authentication status of the predefined mark. That is, a processor may determine whether to form the predefined mark on the object based on whether the predefined mark is deemed to be authentic or inauthentic (e.g., fake, fraudulent, counterfeit, or the like). By way of example, the processor may determine that the predefined mark is authentic based on a determination that a key associated with the predefined mark is valid, e.g., matches a previously stored key or value. Based on a determination that the predefined mark is valid and that the predefined mark is thus authentic, the processor may control fabricating components to fabricate the object with the predefined mark.

However, based on a determination that the predefined mark is inauthentic, the processor may be programmed or otherwise set to perform one of a plurality of actions. For instance, the processor may block fabrication of the object. As another example, the processor may control the fabrication components to fabricate the object without the predefined mark. As a further example, the processor may control the fabrication components to fabricate the object to include the predefined mark without using a particular material, e.g., a special material for the predefined mark, to form the predefined mark.

Through implementation of the apparatuses and methods disclosed herein, the fabrication of objects with predefined marks, e.g., logos, patterns, identifiers, 3D structures, special fonts, special colors, batch identifiers, part identifiers, etc., may be controlled. Particularly, for instance, objects on which inauthentic predefined marks are requested to be formed may not be fabricated or may be fabricated without the predefined marks. Alternatively, objects may be fabricated, but without special materials that may be used to authenticate the objects and/or predefined marks. As a result, the apparatuses and methods disclosed herein may reduce or prevent objects that have certain predefined marks from being fabricated.

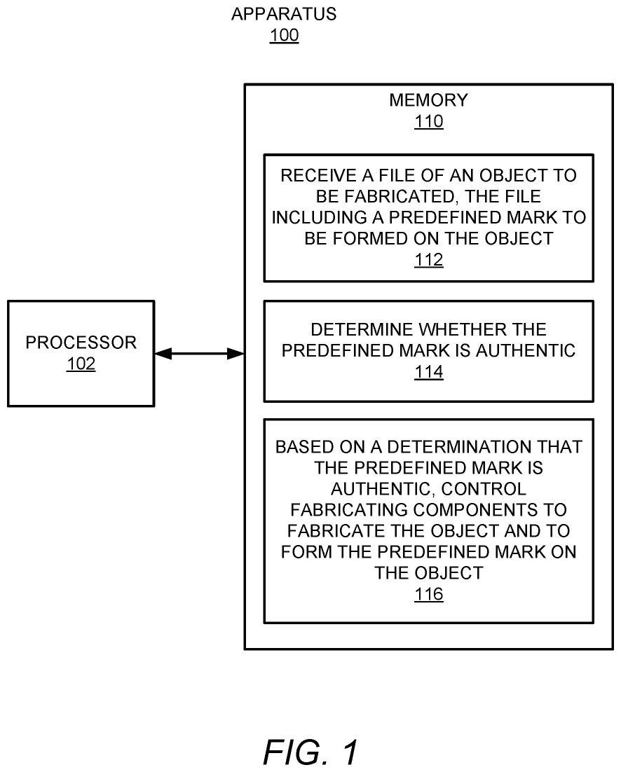

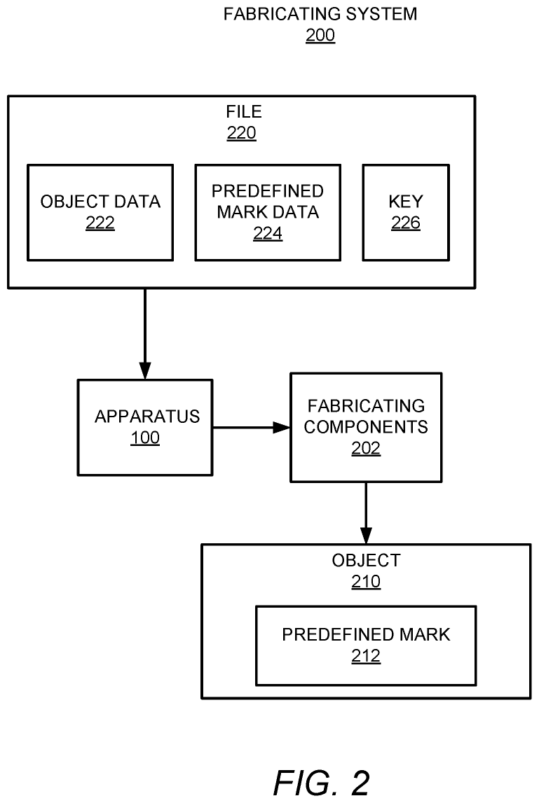

Reference is first made to FIGS. 1 and 2. FIG. 1 shows a block diagram of an example apparatus 100 that may include a processor to control formation of a predefined mark on an object. FIG. 2 shows a block diagram of an example fabricating system 200 within which the apparatus 100 depicted in FIG. 1 may be implemented. It should be understood that the example apparatus 100 depicted in FIG. 1 and/or the fabricating system 200 depicted in FIG. 2 may include additional features and that some of the features described herein may be removed and/or modified without departing from the scopes of the apparatus 100 and/or the fabricating system 200.

According to examples, the apparatus 100 depicted in FIG. 1 may be a computing device, a server, a laptop computer, or the like. In addition, or in other examples, the apparatus 100 may be a control system of the fabricating system 200 depicted in FIG. 2. That is, for instance, the apparatus 100 may control fabricating components 202 in the fabricating system 200 to fabricate an object 210 with a predefined mark 212. As used herein, an object may be a sheet of media, a fabricated 3D object, or the like.

In some examples, the fabricating components 202 may include printing components as well as other components for forming images onto objects (e.g., sheets of media). In these examples, the fabricating system 200 may be a media printer, such as a laser printer or an inkjet printer. In other examples, the fabricating components 202 may include components for fabricating 3D objects. In these examples, the fabricating system 200 may be a 3D fabrication system and may fabricate 3D objects through any of a variety of 3D fabrication processes, such as modeling that may use different ink materials to selectively fuse particles of build material together to form 3D objects.

As shown in FIG. 1, the apparatus 100 may include a processor 102 that may control operations of the apparatus 100. In some examples, the processor 102 may control various operations, such as, fabrication by the fabricating components 202. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, the apparatus 100 may include multiple processors 102 without departing from a scope of the apparatus 100.

The apparatus 100 may also include a memory 110 that may have stored thereon machine readable instructions 112-120 (which may also be termed computer readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

The processor 102 may fetch, decode, and execute the instructions 112 to receive a file 220 including data 222 of an object 210 to be fabricated and data 224 of a predefined mark 212 to be formed on the object 210. The data 222 of the object 210 may be machine readable information pertaining to the object 210 that the processor 102 may use to fabricate the object 210 such as physical characteristics of the object 210. The data 224 of the predefined mark 212 may be machine readable information pertaining to the predefined mark 212 that the processor 102 may use to form the predefined mark 212 on the object 210. The data 224 of the predefined mark 212 may include physical characteristics of the object 210, a particular type of material to be used to form the predefined mark 212, text and/or symbols, a specified location on the object 210 at which the predefined mark 212 is to be formed, etc.

The predefined mark 212 may be a fabricating system identifier, a manufacturer identifier, a designer identifier, an author identifier, a logo, a pattern, a batch identifier, a part identifier, and/or the like. In other words, the predefined mark 212 may be a mark that may be used to identify an entity associated with the fabrication of an object 210, which may include the printing of the mark on a media. The predefined mark 212 may also or alternatively be used to prevent unauthorized fabrication of objects 210 and/or unauthorized formation of the predefined mark 212 on fabricated objects 210.

The processor 102 may fetch, decode, and execute the instructions 114 to determine whether the predefined mark 212 is authentic. For instance, the processor 102 may determine whether the predefined mark 212 is properly authorized to be included in the object 210 by the author of material, a designer of material, a manufacturer of an object, a user of the fabricating system 200, or the like. By way of example, the file 220 may include a key 226 associated with the predefined mark 212 and the processor 102 may determine whether the predefined mark 212 is authentic based on a determination as to whether the key 226 is valid. According to examples, when the file 220 is generated or updated to include data 224 of the predefined mark 212, a user, e.g., the manufacturer, the designer, etc., may associate the key 226 with the predefined mark 212. The key 226 may include a unique arrangement of numbers and/or letters.

In addition, the processor 102 may be provided with the key or other form of information to enable the processor 102 to determine whether the key 226 is valid. For instance, the processor 102 may compare the key 226 in the file 220 with a previously stored key or other information and if there is a match, determine that the key 226 is valid and thus, that the predefined mark 212 is authentic. Conversely, in instances in which the processor 102 determines that the key 226 in the file 220 does not match the previously stored key, the processor 102 may determine that the key 226 is invalid and may thus determine that the predefined mark 212 is inauthentic or fake. In some examples, the key 226 may be encrypted in any of a number of suitable manners and the processor 102 may decrypt the key 226 prior to determining whether the key 226 is valid or invalid.

The processor 102 may fetch, decode, and execute the instructions 116 to, based on a determination that the predefined mark 212 is authentic, control fabricating components 202 to fabricate the object 210 and to control the fabricating components 202 to form the predefined mark 212 on the object 210 during fabrication of the object 210. As discussed herein, the fabrication of the object 210 may include printing images on a sheet of media or fabricating a 3D object.

According to examples, the data 224 of the predefined mark 212 may indicate that the predefined mark 212 is to be formed using a particular material that differs from a material used to fabricate the object 210. The particular material may be a special material that may solely be used to print or form the predefined mark 212. For instance, the data 224 of the predefined mark 212 may indicate that the predefined mark 212 is to be formed using a type of ink that is not used to fabricate the object 210. As another example, the data 224 of the predefined mark 212 may indicate that the predefined mark 212 is to be formed using a type of build material that is not used to fabricate the object 210. As a further example, the data 224 of the predefined mark 212 may indicate that the predefined mark 212 is to be printed using a type of ink that is not used to print other images on the object 210. In any regard, the processor 102 may execute the instructions 116 to control the fabricating components 202 to form the predefined mark 212 on the object 210 using the particular material based on a determination that the predefined mark 212 is authentic.

Instead of the machine-readable storage medium 110, the apparatus 100 may include hardware logic blocks that may perform functions similar to the instructions 112-116. In other examples, the apparatus 100 may include a combination of instructions and hardware logic blocks to implement or execute functions corresponding to the instructions 112-116. In any of these examples, the processor 102 may implement the hardware logic blocks and/or execute the instructions 112-116. As discussed herein, the apparatus 100 may also include additional instructions and/or hardware logic blocks such that the processor 102 may execute operations in addition to or in place of those discussed above with respect to FIG. 1.

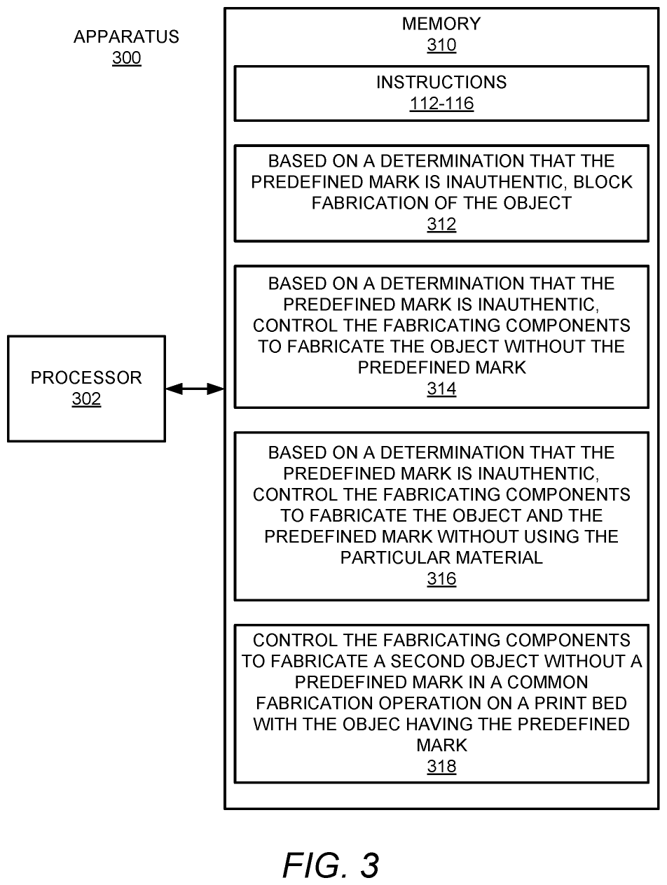

Reference is now made to FIG. 3, which shows a block diagram of another example apparatus 300 that may include a processor 302 to control formation of a predefined mark 212 on an object 210 based on an authentication status of the predefined mark 212. It should be understood that the example apparatus 300 depicted in FIG. 3 may include additional features and that some of the features described herein may be removed and/or modified without departing from the scopes of the apparatus 300. The description of the apparatus 300 is also made with reference to FIGS. 1 and 2.

According to examples, the apparatus 300 may be a computing device, a server, a laptop computer, or the like. In addition, or in other examples, the apparatus 300 may be a control system of the fabricating system 200 depicted in FIG. 2. The apparatus 300 may include a processor 302 that may control operations of the apparatus 300. In some examples, the processor 302 may control various operations, such as, fabricating by the fabricating components. The processor 302 may be similar to the processor 102 depicted in FIG. 1. In addition, although the apparatus 300 has been depicted as including a single processor 302, the apparatus 300 may include multiple processors 302 without departing from a scope of the apparatus 300.

The apparatus 300 may also include a memory 310 that may have stored thereon machine readable instructions 112-120 and 312-324 (which may also be termed computer readable instructions) that the processor 302 may execute. The memory 310 may be similar to the memory 110 depicted in FIG. 1.

The processor 302 may fetch, decode, and execute some or all of the instructions 112-116 as discussed above with respect to FIG. 1. The processor 302 may also fetch, decode, and execute the instructions 312-318 as part of the instructions 116 in instances in which the predefined mark 212 is determined to be inauthentic. The instructions 312-318 may not depend on each other and thus, the processor 302 may execute the instructions 312-318 separately and independently with respect to each other. For instance, a user may instruct the processor 302 to execute a particular one of the instructions 312-316 based on a determination that the predefined mark 212 is inauthentic.

The processor 102 may fetch, decode, and execute the instructions 312 to, based on a determination that the predefined mark 212 is inauthentic, block fabrication by the fabricating components 202 of the object 210. That is, for instance, the processor 302 may control the fabricating components 202 to not fabricate the object 210. Instead, the processor 302 may, for instance, output a message indicating that the object 210 will not be fabricated due to the predefined mark 212 being inauthentic. By way of particular example, the processor 302 may enable fabrication of the object 210 based on the predefined mark 212 matching an identifier of the fabrication system 200. In this example, the processor 302 may determine that the predefined mark 212 is inauthentic based on a determination that the predefined mark 212 does not match the identifier of the fabrication system 200 and may determine that the predefined mark 212 is authentic based on the predefined mark 212 matching the identifier of the fabrication system 200. In this regard, the processor 302 may block the fabrication of objects 210 that are not intended or authorized for fabrication by the processor 302.

The processor 102 may fetch, decode, and execute the instructions 314 to, based on a determination that the predefined mark 212 is inauthentic, control the fabricating components 202 to fabricate the object 210 without forming the predefined mark 212 on the object 210. For instance, the processor 102 may control the fabricating components 202 to fill a space in the object 210 at which the predefined mark 212 was intended to be formed with the material used to form the object 210.

The processor 102 may fetch, decode, and execute the instructions 316 to, based on a determination that the predefined mark 212 is inauthentic, control the fabricating components 202 to fabricate the object 210 and control the fabricating components 202 to form the predefined mark 212 on the object 210 without using the particular material. That is, the processor 102 may control the fabricating components 202 to form the object 210 and the predefined mark 212, but without using the particular material for the predefined mark 212, for instance, as specified in the data 224 of the predefined mark 212.

The processor 102 may fetch, decode, and execute the instructions 318 to control the fabricating components 202 to fabricate a second object without the predefined mark in a common fabrication operation on a print bed with the object 210. That is, for instance, the file 220 or another file may include data for the second object to be fabricated, in which the second object does not include data for a predefined mark to be formed on the second object. However, the processor 302 may control the fabricating components 202 to fabricate the second object with the object 212 in a common fabrication operation, e.g., during a common fabrication operation on a print bed.

Instead of the machine-readable storage medium 310, the apparatus 300 may include hardware logic blocks that may perform functions similar to the instructions 112-120 and 312-318. In other examples, the apparatus 300 may include a combination of instructions and hardware logic blocks to implement or execute functions corresponding to the instructions 112-120 and 312-318. In any of these examples, the processor 302 may implement the hardware logic blocks and/or execute the instructions 112-120 and 312-318. As discussed herein, the apparatus 300 may also include additional instructions and/or hardware logic blocks such that the processor 302 may execute operations in addition to or in place of those discussed above with respect to FIG. 3.

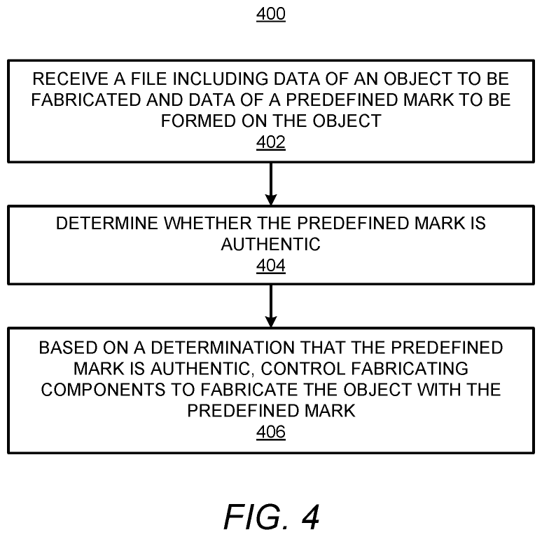

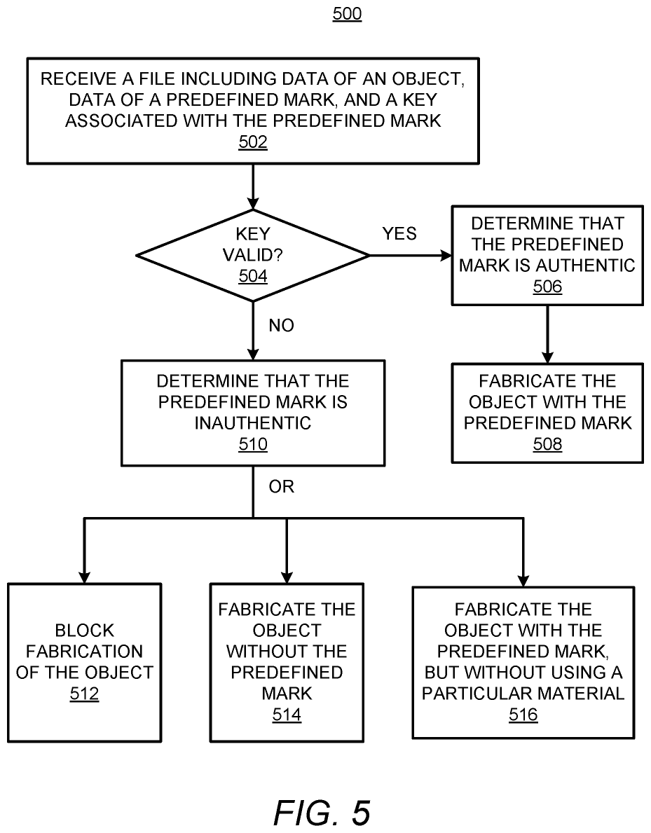

Various manners in which the processor 102, 302 may operate are discussed in greater detail with respect to the methods 400 and 500 depicted in FIGS. 4 and 5. Particularly, FIGS. 4 and 5, respectively, depict flow diagrams of example methods 400 and 500 for controlling formation of a predefined mark 212 on an object 210. It should be understood that the methods 400 and 500 depicted in FIGS. 4 and 5 may include additional operations and that some of the operations described therein may be removed and/or modified without departing from the scopes of the methods 400 and 500. The descriptions of the methods 400 and 500 are made with reference to the features depicted in FIGS. 1-3 for purposes of illustration.

With reference first to FIG. 4, at block 402, the processor 102, 302 may receive a file 220 including data 222 of an object 210 to be fabricated and data 224 of a predefined mark 212 to be formed on the object 210. At block 404, the processor 102, 302, may determine whether the predefined mark 212 is authentic. In addition, based on a determination that the predefined mark is authentic, at block 406, the processor 406 may control fabricating components 202 to fabricate the object 210 with the predefined mark 212. This may include controlling the fabricating components 202 to fabricate a second object that does not include the predefined mark 212 in a common fabrication operation with the object 210.

Turning now to FIG. 5, at block 502, the processor 102, 302 may receive a file 220 including data 222 of an object 210 to be fabricated, data 224 of a predefined mark 212 to be formed on the object 210, and a key 226 associated with the predefined mark 212. At block 504, the processor 102, 302, may determine whether the key 226 is valid. For instance, the processor 102, 302 may compare the key 226 with previously stored information to determine whether the key 226 is valid. Based on a determination that the key 504 is valid, the processor 102, 302 may determine that the predefined mark 212 is authentic at block 506. In addition, at block 508, the processor 102, 302 may control the fabricating components 202 to fabricate the object 210 with the predefined mark 212.

However, based on a determination at block 504 that the key 226 is not valid, the processor 102, 302 may determine, at block 510, that the predefined mark 212 is inauthentic. In addition, the processor 102, 302 may execute one of blocks 512-516. For instance, the processor 102, 302 may block fabrication of the object 210 as indicated at block 512. As another example, the processor 102, 302 may fabricate the object 210 without the predefined mark 212 as indicated at block 514. As a further example, in instances in which the predefined mark 212 is to be formed using a particular material that differs from a material used to fabricate the object 210, the processor 102, 302 may fabricate the object 210 and may form the predefined mark 212 on the object 210, but may do so without using the particular material. In addition, the processor 102, 302 may fill the space in the object 210 originally intended for the predefined mark 212 with the material used to fabricate the object 210.

Some or all of the operations set forth in the methods 400 and 500 may be included as utilities, programs, or subprograms, in any desired computer accessible medium. In addition, the methods 400 and 500 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

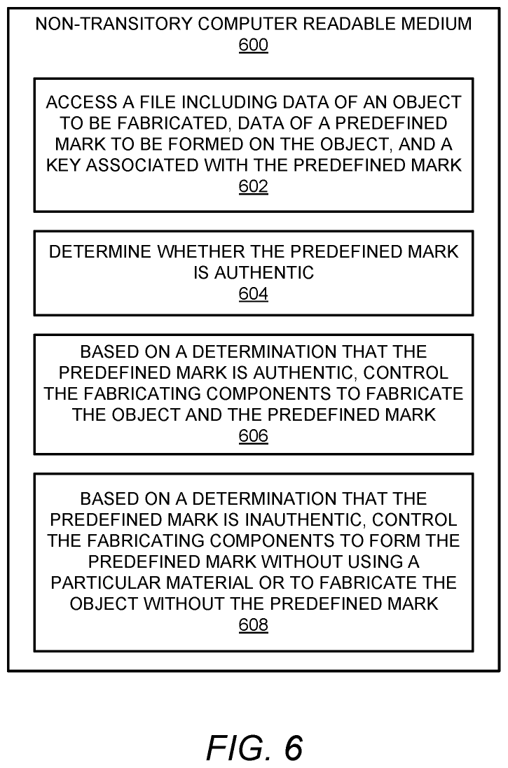

Turning now to FIG. 6, there is shown an example non-transitory machine-readable storage medium 600 for controlling, based on an authentication status of a predefined mark 212, formation of the predefined mark 212 on an object 210. The machine-readable storage medium 600 may be an electronic, magnetic, optical, or other physical storage device that contains or stores executable instructions. The machine-readable storage medium 600 may be, for example, Random Access memory (RAM), an Electrically Erasable Programmable Read-Only Memory (EEPROM), a storage device, an optical disc, and the like.

The non-transitory machine-readable storage medium 600 may have stored thereon machine readable instructions 602-608 that a processor, e.g., the processor 102, 302 may execute. The machine readable instructions 602 may cause the processor to access a file 220 including data of an object 210 to be fabricated, data 224 of a predefined mark 212 to be formed on the object 210, and a key 226 associated with the predefined mark 212. The machine readable instructions 604 may cause the processor to determine, using the key 226, whether the predefined mark 212 is authentic. The machine readable instructions 606 may cause the processor to, based on a determination that the predefined mark 212 is authentic, control fabricating components 202 to fabricate the object 210 and to form the predefined mark 212 on the object 210 during fabrication of the object 210. In addition, the processor may control the fabricating components 202 to form the predefined mark 212 using a particular material that differs from a material used to fabricate the object 210.

However, the machine readable instructions 608 may cause the processor to, based on the determination that the predefined mark is inauthentic, one of: control the fabricating components 202 to form the predefined mark 212 on the object 210 without using the particular material or control the fabricating components 202 to fabricate the object 210 without forming the predefined mark 212 on the object 210.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which are stored machine readable instructions that when executed by the processor, cause the processor to:
receive a file including data of an object to be fabricated and data of a predefined mark to be formed on the object;
determine whether the predefined mark is authentic;
based on a determination that the predefined mark is authentic, control fabricating components to fabricate the object; and
control the fabricating components to form the predefined mark on the object during fabrication of the object.

2. The apparatus of claim 2, wherein the file includes a key associated with the predefined mark, and wherein the instructions are further to cause the processor to:
determine whether the key is valid;
based on a determination that the key is valid, determine that the predefined mark is authentic; and
based on a determination that the key is invalid, determine that the predefined mark is inauthentic.

3. The apparatus of claim 1, wherein the predefined mark comprises an identifier of the fabricating system, an identifier of a designer of the object, an identifier of a manufacturer of the object, an identifier of an author associated with the object, a logo, a batch identifier, a part identifier, or a combination thereof.

4. The apparatus of claim 1, wherein the instructions are further to cause the processor to:
based on a determination that the predefined mark is inauthentic, block fabrication by the fabricating components of the object.

5. The apparatus of claim 1, wherein the instructions are further to cause the processor to:
based on a determination that the predefined mark is inauthentic, control the fabricating components to fabricate the object without forming the predefined mark on the object.

6. The apparatus of claim 1, wherein the predefined mark is to be formed using a particular material that differs from a material used to fabricate the object, wherein the instructions are further to cause the processor to:
control the fabricating components to form the predefined mark on the object using the particular material.

7. The apparatus of claim 1, wherein the predefined mark is to be formed using a particular material that differs from a material used to fabricate the object, wherein the instructions are further to cause the processor to:
based on a determination that the predefined mark is inauthentic,
control the fabricating components to fabricate the object; and
control the fabricating components to form the predefined mark on the object without using the particular material.

8. The apparatus of claim 1, wherein the file identifies a second object to be fabricated without the predefined mark, and wherein the instructions are further to cause the processor to:
control the fabricating components to fabricate the second object without the predefined mark in a common fabrication operation on a print bed with the object.

9. A method comprising:
receiving, by a processor, a file including data of an object to be fabricated and data of a predefined mark to be formed on the object;
determining, by the processor, whether the predefined mark is authentic;
based on a determination that the predefined mark is authentic, controlling, by the processor, fabricating components to fabricate the object with the predefined mark.

10. The method of claim 9, wherein the file includes a key associated with the predefined mark, and the method further comprising:
determining whether the key is valid;
based on a determination that the key is valid, determining that the predefined mark is authentic; and
based on a determination that the key is invalid, determining that the predefined mark is inauthentic.

11. The method of claim 9, further comprising:
based on a determination that the predefined mark is inauthentic, controlling the fabricating components to fabricate the object without forming the predefined mark on the object.

12. The method of claim 9, wherein the predefined mark is to be formed using a particular material that differs from a material used to fabricate the object, the method further comprising:
based on a determination that the predefined mark is inauthentic, controlling the fabricating components to fabricate the object and to form the predefined mark on the object without using the particular material to form the predefined mark.

13. The method of claim 9, wherein the file includes data of a second object to be fabricated without the predefined mark, the method further comprising:
controlling the fabricating components to fabricate the second object without the predefined mark in a common fabricating operation on a print bed with the object.

14. A non-transitory computer readable medium on which is stored machine readable instructions that when executed by a processor, cause the processor to:
access a file including data of an object to be fabricated, data of a predefined mark to be formed on the object, and a key associated with the predefined mark;
determine, using the key, whether the predefined mark is authentic; and
based on a determination that the predefined mark is authentic,
control fabricating components to fabricate the object; and
control the fabricating components to form the predefined mark on the object during fabrication of the object.

15. The non-transitory computer readable medium of claim 14, wherein the predefined mark is to be formed using a particular material that differs from a material used to fabricate the object, wherein the instructions are further to cause the processor to:
based on the determination that the predefined mark is authentic, control the fabricating components to form the predefined mark on the object using the particular material; and
based on the determination that the predefined mark is inauthentic, one of:
control the fabricating components to form the predefined mark on the object without using the particular material; or
control the fabricating components to fabricate the object without forming the predefined mark on the object.
